(19) United States
(12) Patent Application Publication
(10) Pub. No.: US 2012/0295639 A1
(43) Pub. Date: Nov. 22, 2012

(54) DISCOVERING NEARBY PLACES BASED ON AUTOMATIC QUERY

(75) Inventors: Hen Fitoussi, Tel Aviv (IL); Benny Schlesinger, Ramat Hasharon (IL)

(73) Assignee: MICROSOFT CORPORATION, Redmond, WA (US)

(21) Appl. No.: 13/110,011

(22) Filed: May 18, 2011

(51) Int. Cl. H04W 4/02

(52) U.S. Cl. 455/456.3

(57) ABSTRACT

Architecture that enables a user to define areas of interest in advance, and while in motion (e.g., driving, walking, riding, etc.), the architecture automatically notifies the user and/or user device based on notification criteria such as when the user (user device) is near a specific point of interest which matches a category of points of interest (e.g., museum, restaurants, concerts, police radar, etc.), is heading in the direction of the point of interest, anticipates time of arrival to the point of interest, etc. The architecture enables the discovery of points of interest that did not exist when the user defined the location query for the category of points of interest. Moreover, points of interest that change in location and/or time can also be discovered. Implicit location queries can be processed based on a product of interest or service of interest as well.

### BACKGROUND

Information about places of interest is readily available today. For example, users can search the Internet and find new places of interest. However, this process requires a repeated explicit search action, making it tedious and unfeasible while in motion.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture enables a user to define categories of interest in advance, and while in motion (e.g., driving, walking, riding, etc.). For example, the architecture automatically notifies the user when the user is near a point of interest which matches a category of interest (e.g., museum, restaurants, concerts, police radar, etc.). Thus, the user can effortlessly discover new points of interest. Other criteria can be applied other than proximity, such as estimated time of arrival, for example.

The architecture enables the discovery of points of interest that did not exist when the user defined the location query for the categories of interest. Moreover, points of interest that change in location and/or time can also be discovered. Implicit location queries can be processed based on a product of interest or service of interest as well. For example, an implicit location query can be processed where if the user specifies a product (e.g., a camera), the notifications can be provided when the user is near a specific store or stores that sell and/or have information about the camera.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a location discovery system in accordance with the disclosed architecture.

FIG. 2 illustrates an alternative embodiment of a location discovery system in accordance with the disclosed architecture.

FIG. 3 illustrates yet another alternative embodiment of a location discovery system that includes a security component in accordance with the disclosed architecture.

FIG. 4 illustrates an exemplary definition component user interface dialog via which a user can define categories of interest.

FIG. 5 illustrates an exemplary notification dialog that notifies the user of a nearby point of interest.

FIG. 6 illustrates a flow diagram for an optimized implementation.

FIG. 7 illustrates a pull approach system between a client and a server for discovering nearby places.

FIG. 8 illustrates a location discovery method in accordance with the disclosed architecture.

FIG. 9 illustrates further aspects of the method of FIG. 8.

FIG. 10 illustrates a block diagram of a computing system that executes automatic discovery of nearby geographic locations in accordance with the disclosed architecture.

### DETAILED DESCRIPTION

The disclosed architecture enables the discovery of points of interest while in motion (e.g., driving, walking, riding, etc.), and automatically notifies the user when the user is near a point of interest. A geolocation technology can be employed to track the user device (e.g., a mobile phone) and compute the proximity of the user device to the point of interest. When certain criteria are met (e.g., proximity to the point of interest, anticipated time of arrival at the point of interest, etc.), the user can be automatically notified of the nearby point of interest. For example, if the user (and user device) is at a 1-mile distance for the point of interest, a notification can be triggered to the user (the user device), which indicates additional information about the point of interest, for example. In another example, by processing the geolocation information it is computed that the user is approaching the point of interest at a certain velocity, the time of arrival at the point of interest and/or a virtual notification perimeter (e.g., geo-fence) can trigger the notification to the user (device).

The user can define categories of the points of interest such as restaurants or gas stations, for example. Accordingly, when the user's device is within a predefined proximity of a restaurant or a gas station, the user is notified of the specific restaurant or specific gas station.

When utilizing proximity as the criteria, the proximity relative to a point of interest can be determined according to geo-fencing technology. A geo-fence is a predefined virtual perimeter (e.g., within a two mile radius of a point of interest) of a physical geographic area.

The architecture comprises a definition phase where the user defines categories of points of interest (e.g., theaters) for which the user desires to find specific geographic locations thereof. The geographic locations can be stationary, such as Japanese restaurants, shoe stores, cinemas, etc. Alternatively, the user can be interested in moving or temporary geographic locations or points of interest, such as live concerts, police radar checks, special sales (e.g. “XXX for less than $100”), etc. The architecture also finds applicability to persons, in general, such as finding the location of family members that may be moving or lingering, for example. In one implementation, the definition phase can be automated by learning the user's categories of interest automatically.

With respect to a notification phase, while the user is moving, the user device continuously monitors the user geographical location and alerts the user of points of interest that match categories of interest in the vicinity of the user.

The client location (user device) can be determined and obtained using geo-location technologies such as global positioning system (GPS), cell tower systems (triangulation), Wi-Fi™ (used to certify the interoperability of wireless computer networking devices) access points, the mobile operator, and so on.

The geo-location information for points of interest can be stored in a storage component such as a repository. The points of interest and associated geo-location information can be obtained from various sources such as web searches, and read from databases, for example.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

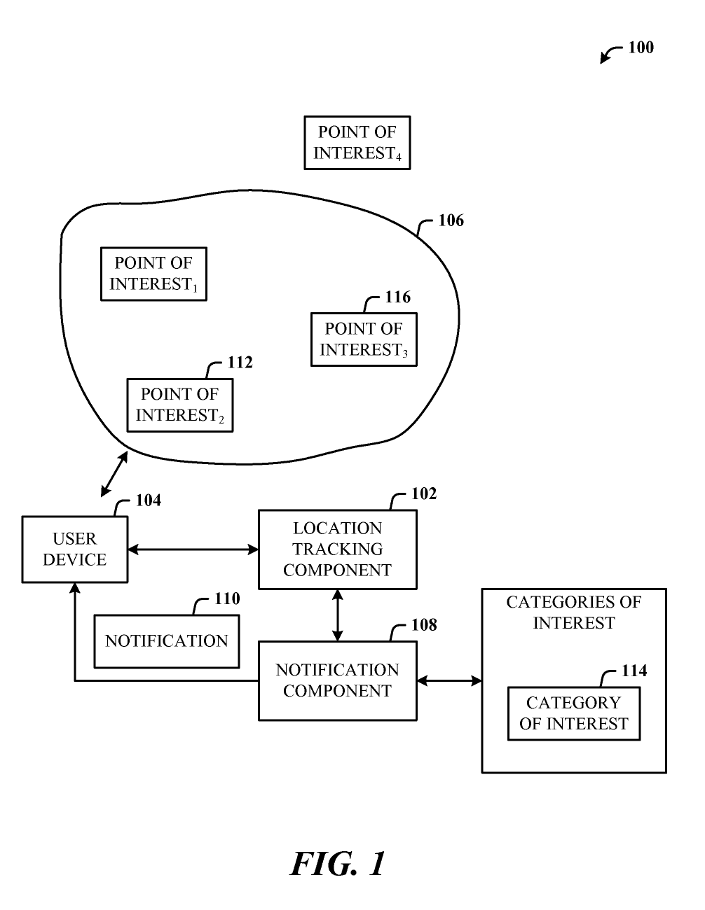

FIG. 1 illustrates a location discovery system 100 in accordance with the disclosed architecture. The system 100 includes a location tracking component 102 that tracks geographical location (e.g., relative to a geographic area or region 106) of a user device 104 (e.g., a mobile phone), and a notification component 108 that sends a notification 110 based on criteria (e.g., proximity) associated with the user device 104 as related to a point of interest 112. The point of interest 112 corresponds to a specified category of interest 114. The proximity is determined based on the geographical location of a user device 104 relative to the point of interest 112.

The notification component 108 sends the notification 110 to the user device 104 in response to the location tracking component 102 detecting proximity of the user device 104, as a criterion, based on a geo-fencing technology. Points of interest (e.g., point of interest 112 and a third point of interest 116) associated with the user can be learned based on a history developed from previous points of interest accessed by the user. The user device 104 can be a mobile phone that is tracked geographically and receives the notification 110 of nearby points of interest based on geo-fencing. Note that the notification can be presented in one or more ways such as audio, image, video, user interface popup dialog, ringtones, beeps, etc.

Note that the architecture described herein can process multiple geo-fences concurrently to discover points of interest associated with different categories of interest. For example, the geolocation of the user device can trigger notifications for restaurants as well as theaters. This can be based on user search queries where the user chooses to dine before or after a theater event.

Additionally, the query (e.g., implicit or explicit) allows the user to discover a point of interest for a specific purpose such as a product or service. For example, if the user wants to find a restaurant that serves a specific food, this specific query can be for a food FOOD-X, which query is then processed to discover all nearby restaurants that meet this food criteria. Thus, the query for FOOD-X translates to a location.

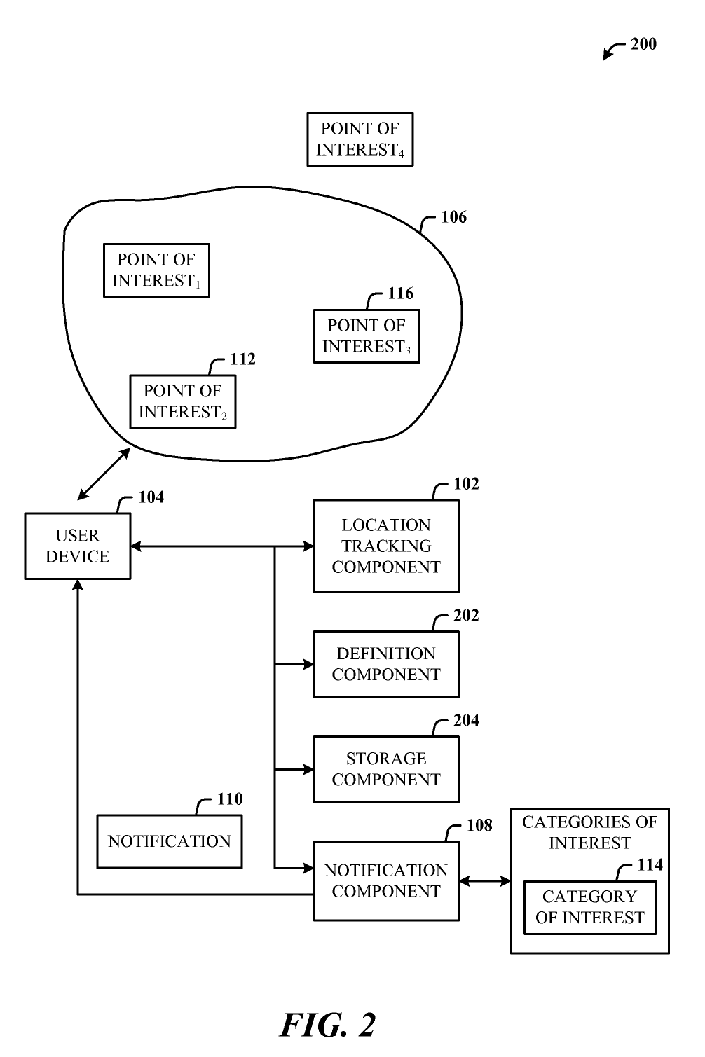

FIG. 2 illustrates an alternative embodiment of a location discovery system 200 in accordance with the disclosed architecture. The system 200 includes the entities and component of the system 100 of FIG. 1. Additionally, the system 200 includes a definition component 202 via which one or more categories of interest can be specified. In other words, a user interface is provided as part of the definition component 202 via which the user can enter category information associated with categories of points of interest.

The definition component 202 can receive a query which specifies a product or service related to a point of interest. The notification component 108 sends the notification 110 based on proximity of the user device 104 to the point of interest 112 that provides the product or service.

The system 200 can further comprise a storage component 204 (e.g., a repository) that stores geographical location information of points of interest and the specified category of interest. Note that the storage component 204 can be local to the user device 104, storage remote from the user device 104, or as a shared storage over both the user device 104 and the remote storage. The point of interest of the user is mapped to the category of interest in the storage component 204. The system 200 uses the client location to query the repository based on the user's categories of interest, and prompts the user when discovering an interesting location.

The point-of-interest information associated with the user can be obtained (learned) by various ways, for example, by tracking users interests as determined by accessing websites and webpages, user profile information, and so on.

The geographical location information of points of interest in the storage component 204 can also be updated to include new points of interest that are automatically mapped to the category of interest. The new points of interest can be associated with changes in time and location. In other words, a point of interest (e.g., a police checkpoint) can change location, and later, the same point of interest can change to a new location and at a later time.

The notification component 108 can query the storage component 204 based on the geographical location of the user device 104 and the storage component 204 returns points of interest related to the specified category of interest.

Put another way, a location discovery system is disclosed that comprises a location tracking component of a device that tracks geographical location of the device relative to categories of geographical points of interest, a repository (e.g., the storage component) of location information that stores and relates the location information to the categories of the geographical points of interest. The location information can be updated as to changes in location of existing points of interest and updated with new points of interest. A notification component queries the repository based on the geographical location of the device and presents a notification via the device based on proximity of the device to points of interest. The system can further comprise a definition component via which the category of interest is specified. The definition component receives a query (e.g., implicit) that specifies a product or service related to a point of interest. The notification component sends a notification to the user device based on the criteria (e.g., proximity of the user device to the point of interest).

The repository maps existing points of interest to a category of interest, the changes in location of the existing points of interest to a category of interest, and new points of interest to a category of interest. The device can be a mobile phone that communicates with a server to receive the notification of nearby points of interest associated with the categories of points of interest.

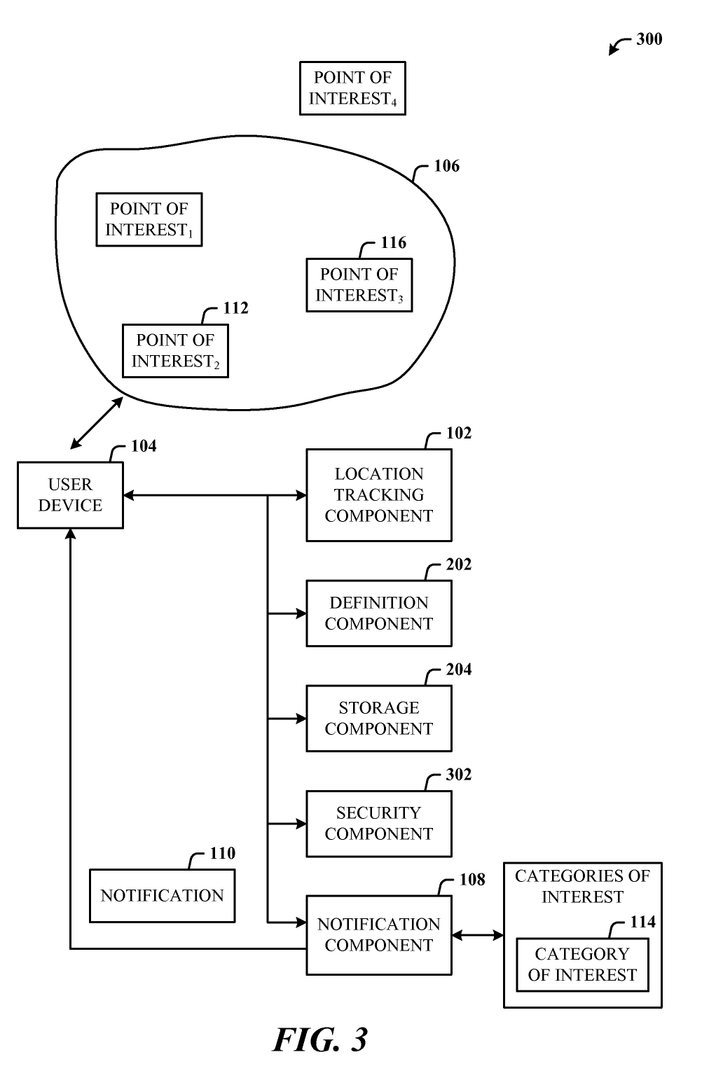

FIG. 3 illustrates yet another alternative embodiment of a location discovery system 300 that includes a security component 302 in accordance with the disclosed architecture. The security component 302 provides authorized and secure handling of user information. The security component 302 allows the user of the user device to opt-in and opt-out of tracking information as well as personal information that may be obtained and utilized thereafter. Accordingly, the user can be provided with notice of the collection of personal information, for example, and the opportunity to provide or deny consent to do so.

Consent can take several forms. Opt-in consent can impose on the user to take an affirmative action before the data (personal, tracking, etc.) is collected. Alternatively, opt-out consent can impose on the user to take an affirmative action to prevent the collection of data before that data is collected. This is similar to implied consent in that by doing nothing, the user allows the data collection after having been adequately informed.

The security component 302 also allows the user to access and update profile information. For example, the user can view the personal and/or tracking data that has been collected, and provide corrections. Where sensitive personal information such as health and financial information can be tracked and obtained during subscription or thereafter, the security component 302 ensures that the data is housed using security measures appropriate for the sensitivity of the data. Moreover, vendor access to such information can be restricted using the security component 302 for access only to authorized viewers.

The security component 302 ensures the proper collection, storage, and access to the user information while allowing for the dynamic selection and presentation of the content, features, and/or services to provide the benefits of a richer user experience and access to more relevant information.

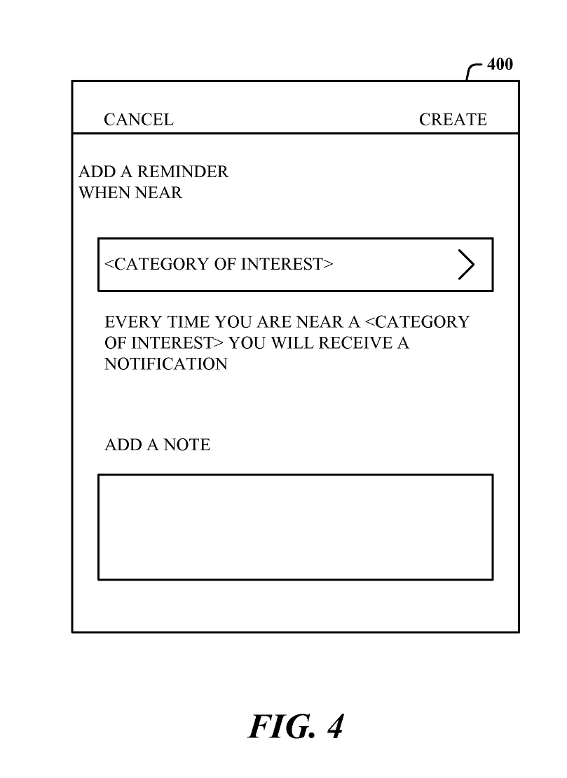

FIG. 4 illustrates an exemplary definition component user interface dialog 400 via which a user can define categories of interest. The user interface dialog 400 provides the capability to create categories of interest and cancel a category of interest. For example, if the category of interest is Japanese restaurants, the user will receive a notification of a specific Japanese restaurant (e.g., Japan Restaurant A) when the user device is within a predefined proximity (distance criteria) of the Japan Restaurant A.

It can be the case that there are multiple Japanese restaurant points of interest of the Japanese restaurant category that meet the proximity criteria such that the user is then presented with a list of those Japanese restaurant points of interest. As is described herein below, the user can then select an option associated with a Japanese restaurant point of interest to then be presented with additional more detailed information.

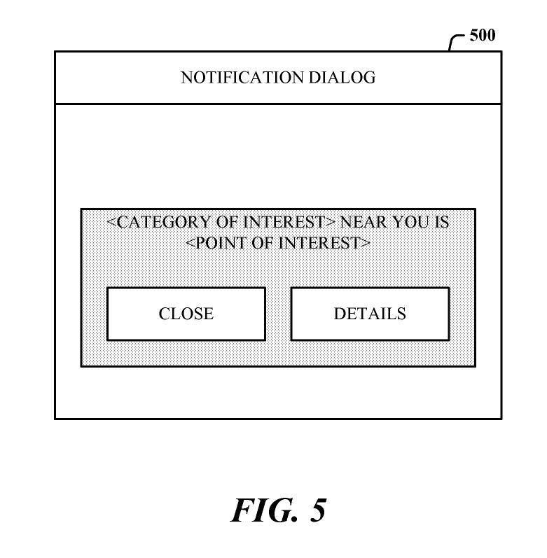

FIG. 5 illustrates an exemplary notification dialog 500 that notifies the user of a nearby point of interest. The dialog 500 can be presented using any presentation program such as a browser, for example, of a mobile device (e.g., a cell phone). Here, the dialog 500 indicates the category of interest (e.g., Japanese restaurants) and the specific point of interest (e.g., Japanese Restaurant A).

The dialog 500 provides the options to the user to close the dialog 500 and to select a details button for more detailed information about the specific Japanese Restaurant A. The depicted dialog 500 is not to be construed as limiting in any way since, other options and information can be provided as desired.

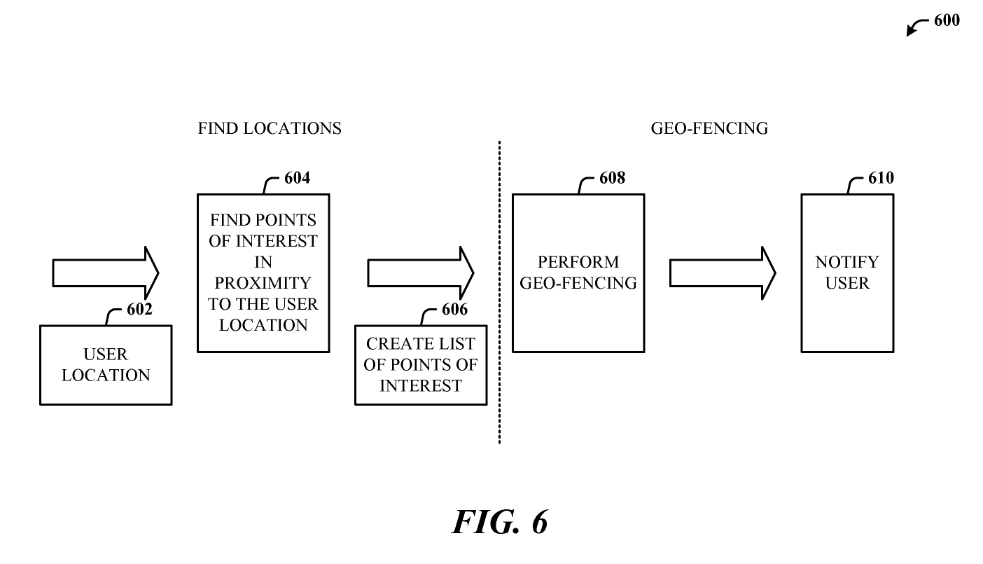

FIG. 6 illustrates a flow diagram 600 for an optimized implementation. One example implementation conserves battery power in the user device, network traffic, and computing power separates the processing to two steps: find locations around the user and geo-fencing. At 602, the geographic location of the user is tracked and known (via the user device). At 604, points of interest in proximity to the user location are computed. The points of interest are determined based on one or more categories of interest defined by the user and/or learned based on user history relative to previous points of interest visited (and/or not visited). At 606, a list of points of interest is created.

At 608, geo-fencing can be performed. Geo-fencing compares the user location (at 602) to the locations associated with the corresponding points of interest of the created list (at 606). Any point of interest that meets the proximity criteria of the virtual perimeter of the geo-fence is sent in a notification to the user, at 610. The notification can include multiple points of interest that meet the proximity criteria of the geo-fence.

Each of the blocks in the flow diagram 600 can execute on the client, on a server, or a combination of the client and the server, thereby creating the following alternatives.

In a client-only scenario, the client (of the user device) performs the queries for locations on the client, implicitly, in the background based on location changes of the user device.

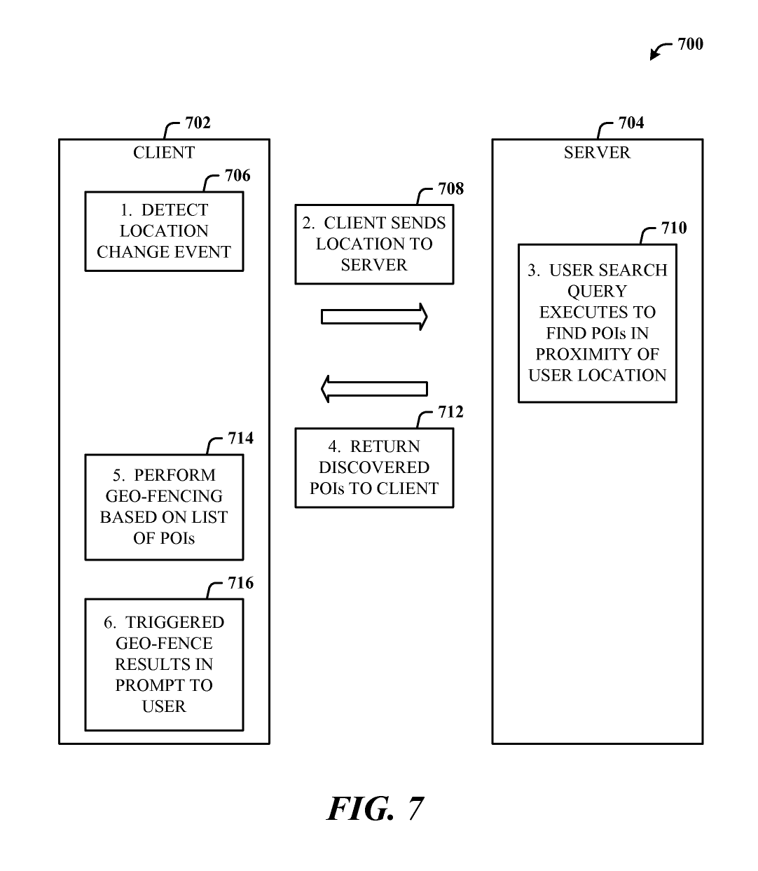

In a combined client/server scenario, the queries are generated on the server, using the current client location. The resulting potential locations are sent to the client for further local processing (geo-fencing). Two variations for passing the location information from the server to the client are a pull approach and a push approach. In the pull approach, the client sends its location to the server and receives the list of points of interest. The pull approach is illustrated in the FIG. 7. In the push approach, the server pushes relevant points of interest to the client based on the client location (e.g., as obtained from the mobile operator).

In a server-only scenario, both the queries and the geo-fencing are executed on the server. Only the alerts to the user are pushed to the client.

FIG. 7 illustrates a pull approach system 700 between a client 702 and a server 704 for discovering nearby places. At 706, the client 702 detects a location change of the user device. At 708, the client 702 sends its location to the server 704. At 710, the server 704 executes a user search query to find points of interest (POIs) in proximity of the user location. At 712, the server 704 returns a list of discovered POIs to the client 702. At 714, the client 702 performs geo-fencing based on the list. At 716, any triggered geo-fences results in notification to the client 702 for presentation to the device user.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

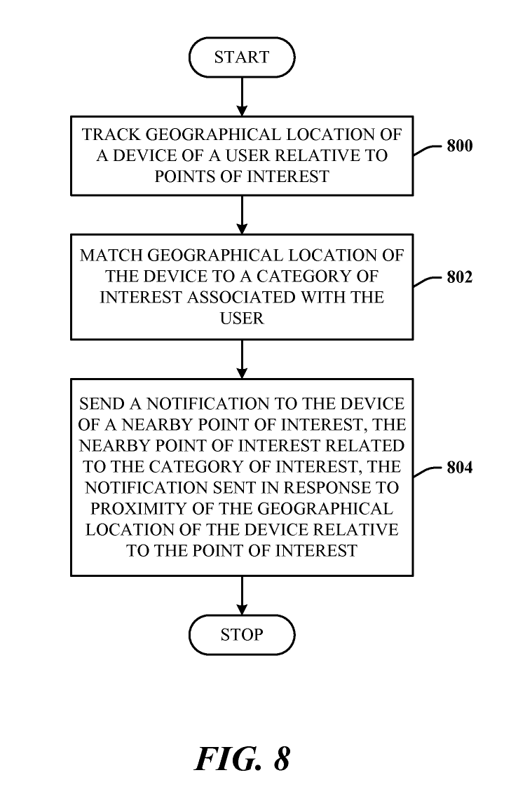

FIG. 8 illustrates a location discovery method in accordance with the disclosed architecture. At 800, geographical location of a device of a user is tracked relative to points of interest. At 802, the geographical location of the device is matched to a category of interest associated with the user. At 804, a notification is sent (e.g., to the user) to the device of a nearby point of interest. The nearby point of interest is related to the category of interest, and the notification is sent in response to the proximity of the geographical location of the device relative to the point of interest. Note that the notification need not be sent to the user for perception, but to the user device to trigger application launch and application actions such as to begin capturing data (e.g., images via a device camera, audio signals via a device microphone, geolocation tracking data, clock data, orientation data via an onboard accelerometer, etc.).

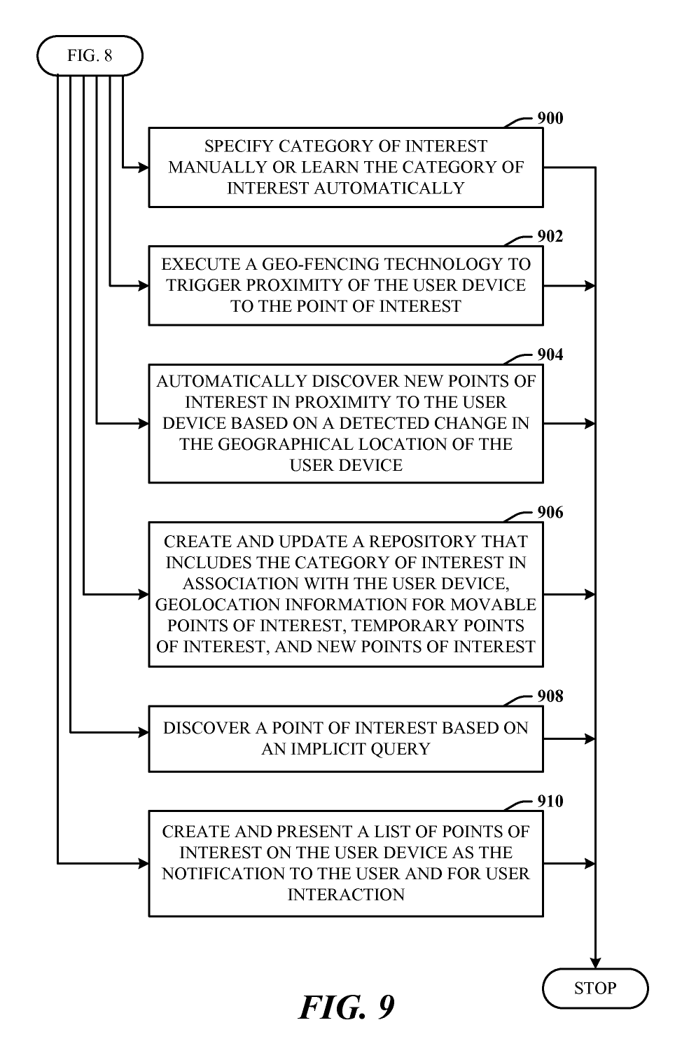

FIG. 9 illustrates further aspects of the method of FIG. 8. Note that the flow indicates that each block can represent a step that can be included, separately or in combination with other blocks, as additional aspects of the method represented by the flow chart of FIG. 8. At 900, the category of interest is specified manually or the category of interest is learned automatically. At 902, a geo-fencing technology is executed to trigger proximity of the user device to the point of interest. At 904, new points of interest in proximity to the user device are automatically discovered based on a detected change in the geographical location of the user device. At 906, a repository is created and updated that includes the category of interest in association with the user device, geolocation information for movable points of interest, temporary points of interest, and new points of interest. At 908, a point of interest is discovered based on an implicit query. At 910, a list of points of interest is created and presented on the user device as the notification to the user and for user interaction.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in volatile or non-volatile storage media), a module, a thread of execution, and/or a program. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

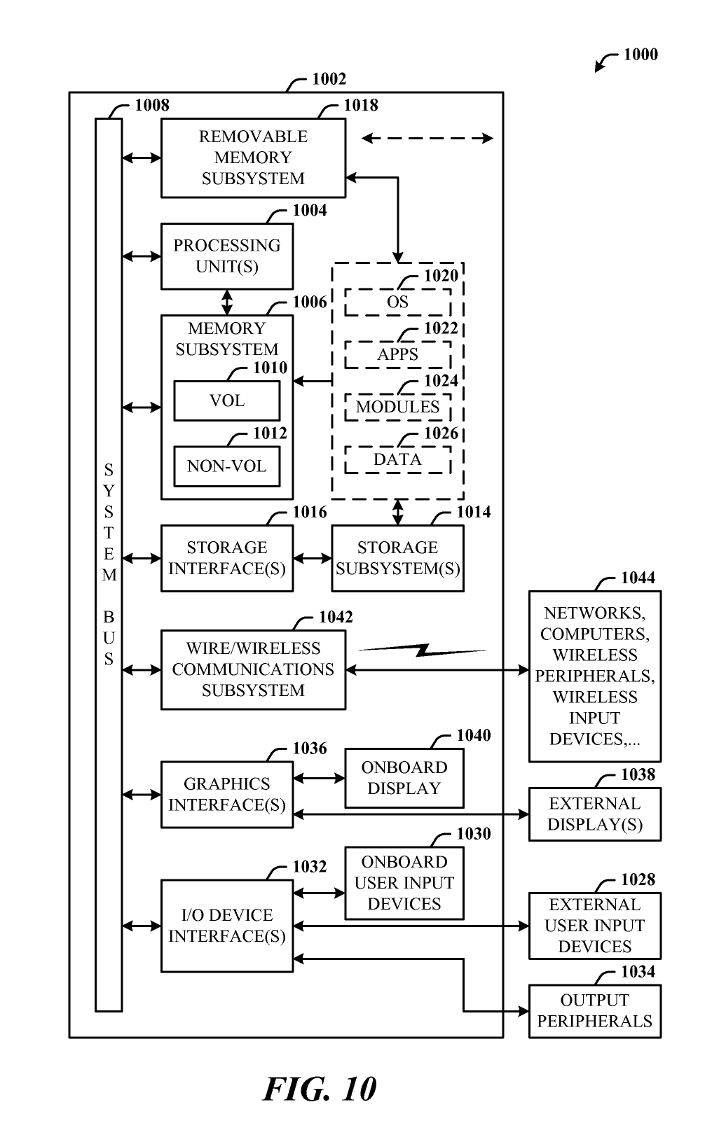

Referring now to FIG. 10, there is illustrated a block diagram of a computing system 1000 that executes automatic discovery of nearby geographic locations in accordance with the disclosed architecture. However, it is appreciated that the some or all aspects of the disclosed methods and/or systems can be implemented as a system-on-a-chip, where analog, digital, mixed signals, and other functions are fabricated on a single chip substrate. In order to provide additional context for various aspects thereof, FIG. 10 and the following description are intended to provide a brief, general description of the suitable computing system 1000 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 1000 for implementing various aspects includes the computer 1002 having processing unit(s) 1004, a computer-readable storage such as a system memory 1006, and a system bus 1008. The processing unit(s) 1004 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 1006 can include computer-readable storage (physical storage media) such as a volatile (VOL) memory 1010 (e.g., random access memory (RAM)) and non-volatile memory (NON-VOL) 1012 (e.g., ROM, EPROM, EEPROM, etc.). A basic input/output system (BIOS) can be stored in the non-volatile memory 1012, and includes the basic routines that facilitate the communication of data and signals between components within the computer 1002, such as during startup. The volatile memory 1010 can also include a high-speed RAM such as static RAM for caching data.

The system bus 1008 provides an interface for system components including, but not limited to, the system memory 1006 to the processing unit(s) 1004. The system bus 1008 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 1002 further includes machine readable storage subsystem(s) 1014 and storage interface(s) 1016 for interfacing the storage subsystem(s) 1014 to the system bus 1008 and other desired computer components. The storage subsystem(s) 1014 (physical storage media) can include one or more of a hard disk drive (HDD), a magnetic floppy disk drive (FDD), and/or optical disk storage drive (e.g., a CD-ROM drive DVD drive), for example. The storage interface(s) 1016 can include interface technologies such as EIDE, ATA, SATA, and IEEE 1394, for example.

One or more programs and data can be stored in the memory subsystem 1006, a machine readable and removable memory subsystem 1018 (e.g., flash drive form factor technology), and/or the storage subsystem(s) 1014 (e.g., optical, magnetic, solid state), including an operating system 1020, one or more application programs 1022, other program modules 1024, and program data 1026.

The operating system 1020, one or more application programs 1022, other program modules 1024, and/or program data 1026 can include entities and components of the system 100 of FIG. 1, entities and components of the system 200 of FIG. 2, entities and components of the system 300 of FIG. 3, the user interface dialog 400 of FIG. 4, the notification dialog 500 of FIG. 5, the flow diagram 600 of FIG. 6, some or all of the entities and components of the pull approach system 700 of FIG. 7, and the methods represented by the flowcharts of FIGS. 8 and 9, for example.

When using a mobile phone, the operating system, one or more application programs, other program modules, and/or program data can include entities and components of the system 100 of FIG. 1, entities and components of the system 200 of FIG. 2, entities and components of the system 300 of FIG. 3, the user interface dialog 400 of FIG. 4, the notification dialog 500 of FIG. 5, the flow diagram 600 of FIG. 6, some or all of the entities and components of the pull approach system 700 of FIG. 7, and the methods represented by the flowcharts of FIGS. 8 and 9, for example.

Generally, programs include routines, methods, data structures, other software components, etc., that perform particular tasks or implement particular abstract data types. All or portions of the operating system 1020, applications 1022, modules 1024, and/or data 1026 can also be cached in memory such as the volatile memory 1010, for example. It is to be appreciated that the disclosed architecture can be implemented with various commercially available operating systems or combinations of operating systems (e.g., as virtual machines).

The storage subsystem(s) 1014 and memory subsystems (1006 and 1018) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media that can be accessed by the computer 1002 and includes volatile and non-volatile internal and/or external media that is removable or non-removable. For the computer 1002, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 1002, programs, and data using external user input devices 1028 such as a keyboard and a mouse. Other external user input devices 1028 can include a microphone, an IR (infrared) remote control, a joystick, a game pad, camera recognition systems, a stylus pen, touch screen, gesture systems (e.g., eye movement, head movement, etc.), and/or the like. The user can interact with the computer 1002, programs, and data using onboard user input devices 1030 such a touchpad, microphone, keyboard, etc., where the computer 1002 is a portable computer, for example. These and other input devices are connected to the processing unit(s) 1004 through input/output (I/O) device interface(s) 1032 via the system bus 1008, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 1032 also facilitate the use of output peripherals 1034 such as printers, audio devices, camera devices, and so on, such as a sound card and/or onboard audio processing capability.

One or more graphics interface(s) 1036 (also commonly referred to as a graphics processing unit (GPU)) provide graphics and video signals between the computer 1002 and external display(s) 1038 (e.g., LCD, plasma) and/or onboard displays 1040 (e.g., for portable computer). The graphics interface(s) 1036 can also be manufactured as part of the computer system board.

The computer 1002 can operate in a networked environment (e.g., IP-based) using logical connections via a wired/wireless communications subsystem 1042 to one or more networks and/or other computers. The other computers can include workstations, servers, routers, personal computers, microprocessor-based entertainment appliances, peer devices or other common network nodes, and typically include many or all of the elements described relative to the computer 1002. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 1002 connects to the network via a wired/wireless communication subsystem 1042 (e.g., a network interface adapter, onboard transceiver subsystem, etc.) to communicate with wired/wireless networks, wired/wireless printers, wired/wireless input devices 1044, and so on. The computer 1002 can include a modem or other means for establishing communications over the network. In a networked environment, programs and data relative to the computer 1002 can be stored in the remote memory/storage device, as is associated with a distributed system. It will be appreciated that the network connections shown are exemplary and other means of establishing a communications link between the computers can be used.

The computer 1002 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

The illustrated and described aspects can be practiced in distributed computing environments where certain tasks are performed by remote processing devices that are linked through a communications network. In a distributed computing environment, program modules can be located in local and/or remote storage and/or memory system.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented location discovery system, comprising:
a location tracking component that tracks geographical location of a user device;
a notification component that sends a notification based on criteria associated with the user device as related to a point of interest, the point of interest corresponds to a specified category of interest; and
a processor that executes computer-executable instructions associated with at least one of the location tracking component or the notification component.

2. The system of claim 1, wherein the notification component sends the notification to the user device in response to the location tracking component detecting proximity of the user device, as a criterion, based on a geo-fencing technology.

3. The system of claim 1, further comprising a definition component via which the category of interest is specified.

4. The system of claim 3, wherein the definition component receives a query that specifies a product or service related to a point of interest, the notification component sends a notification to the user device based on the criteria.

5. The system of claim 1, further comprising a storage component that stores geographical location information of points of interest and the specified category of interest, the point of interest of the user is mapped to the category of interest in the storage component.

6. The system of claim 5, wherein the geographical location information of points of interest in the storage component is updated to include new points of interest that are automatically mapped to the category of interest, the new points of interest associated with changes in time and location.

7. The system of claim 5, wherein the notification component queries the storage component based on the geographical location of the user device and the storage component returns points of interest related to the specified category of interest.

8. The system of claim 1, wherein points of interest associated with the user are learned based on a history developed from previous points of interest.

9. The system of claim 1, wherein the user device is mobile phone that is tracked geographically and receives the notification of nearby points of interest based on geo-fencing.

10. A computer-implemented location discovery system, comprising:
a location tracking component of a device that tracks geographical location of the device relative to categories of geographical points of interest;
a repository of location information that stores and relates the location information to the categories of the geographical points of interest, the location information updated as to changes in location of existing points of interest and updated with new points of interest;
a notification component that queries the repository based on the geographical location of the device and presents a notification via the device based on proximity of the device to points of interest; and
a processor that executes computer-executable instructions associated with at least one of the location tracking component or the notification component.

11. The system of claim 10, further comprising a definition component via which the category of interest is specified, the definition component receives an implicit query which specifies a product or service related to a point of interest.

12. The system of claim 10, wherein the repository maps existing points of interest to a category of interest, the changes in location of the existing points of interest to a category of interest, and new points of interest to a category of interest.

13. The system of claim 10, wherein the device is mobile phone that communicates with a server to receive the notification of nearby points of interest associated with the categories of points of interest.

14. A computer-implemented location discovery method, comprising acts of:
tracking geographical location of a device of a user relative to points of interest;
matching the geographical location of the device to a category of interest associated with the user;
sending a notification to the device of a nearby point of interest, the nearby point of interest related to the category of interest, the notification sent in response to proximity of the geographical location of the device relative to the point of interest; and
utilizing a processor that executes instructions stored in memory to perform at least one of the acts of tracking, matching, or sending.

15. The method of claim 14, further comprising specifying the category of interest manually or learning the category of interest automatically.

16. The method of claim 14, further comprising executing a geo-fencing technology to trigger proximity of the user device to the point of interest.

17. The method of claim 14, further comprising automatically discovering new points of interest in proximity to the user device based on a detected change in the geographical location of the user device.

18. The method of claim 14, further comprising creating and updating a repository that includes the category of interest in association with the user device, geolocation information for movable points of interest, temporary points of interest, and new points of interest.

19. The method of claim 14, further comprising discovering a point of interest based on an implicit query.

20. The method of claim 14, further comprising creating and presenting a list of points of interest on the user device as the notification to the user and for user interaction.
